(19) United States
(12) Patent Application Publication
(10) Pub. No.: US 2018/0287858 A1
(43) Pub. Date: Oct. 4, 2018

(54) TECHNOLOGIES FOR EFFICIENTLY MANAGING LINK FAULTS BETWEEN SWITCHES

(71) Applicant: Intel Corporation, Santa Clara, CA (US)

(72) Inventors: Mario Flajslik, Hudson, MA (US); Eric R. Borch, Fort Collins, CO (US); Michael A. Parker, Santa Clara, CA (US)

(21) Appl. No.: 15/475,606

(22) Filed: Mar. 31, 2017

(51) Int. Cl. H04L 12/24; H04L 12/707

(52) U.S. Cl. CPC H04L 41/0654; H04L 45/22

(57) ABSTRACT

Technologies for efficiently managing link faults between switches include a fabric monitor. The fabric monitor is to generate routing rules indicative of an ordering of a plurality of global switches connected to a plurality of node switches in a group, monitor a status of links between the global switches and the node switches to determine whether one or more downlinks have failed in the group, adjust, in response to a determination that one or more downlinks have failed in the group, the ordering of the global switches in the routing rules, and send the adjusted routing rules to the group. Other embodiments are also described and claimed.

### STATEMENT REGARDING FEDERALLY SPONSORED RESEARCH

This invention was made with Government support under contract number H98230A-13-D-0124 awarded by the Department of Defense. The Government has certain rights in this invention.

### BACKGROUND

Large scale indirect network topologies, such as 3-level fat trees, typically include tens of thousands of links connecting switches for routing packets (i.e., units of data). Even though the likelihood of failure of an individual link or port on a switch (a “link fault”) is relatively small, the large scale of the system leads to a situation where one or more links in the network are typically inoperative. If there are alternative paths instead of the inoperative link, a typical routing algorithm may ignore the inoperative link. However, if the inoperative link is the only minimal path to the destination, a typical system will route packets in a path around the inoperative link by taking multiple bypass hops. Such paths with extra hops can form cycles and result in network deadlock. To avoid deadlock, switches typically use a dedicated virtual channel for fault routing. While using virtual channels for fault routing is effective in avoiding deadlock, the virtual channels consume processing and memory resources of the switches and typically are reserved on all switches regardless of whether there are failed links that necessitate the virtual channels. As such, using virtual channels may decrease the efficiency of resource utilization in switches. Alternatively, in some systems, switches that detect a deadlock condition will drop packets to mitigate or eliminate the deadlock. However, by dropping packets, such switches reduce the reliability of delivering packets through the network.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a system for efficiently managing link faults between switches;

FIG. 2 is a simplified block diagram of at least one embodiment of a fabric monitor of the system of FIG. 1;

FIG. 3 is a simplified block diagram of an environment that may be established by the fabric monitor of FIGS. 1 and 2;

FIG. 4 is a simplified block diagram of an environment that may be established by a global switch of FIG. 1;

FIG. 5 is a simplified block diagram of an environment that may be established by a node switch of FIG. 1;

FIG. 6-7 are a simplified flow diagram of at least one embodiment of a method for managing link faults that may be performed by the fabric monitor of FIGS. 1 and 2;

FIGS. 8-9 are a simplified flow diagram of at least one embodiment of a method for routing packets that may be performed by a global switch of FIG. 1; and

FIGS. 10-11 are a simplified flow diagram of at least one embodiment of a method for routing packets that may be performed by a node switch of FIG. 1.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

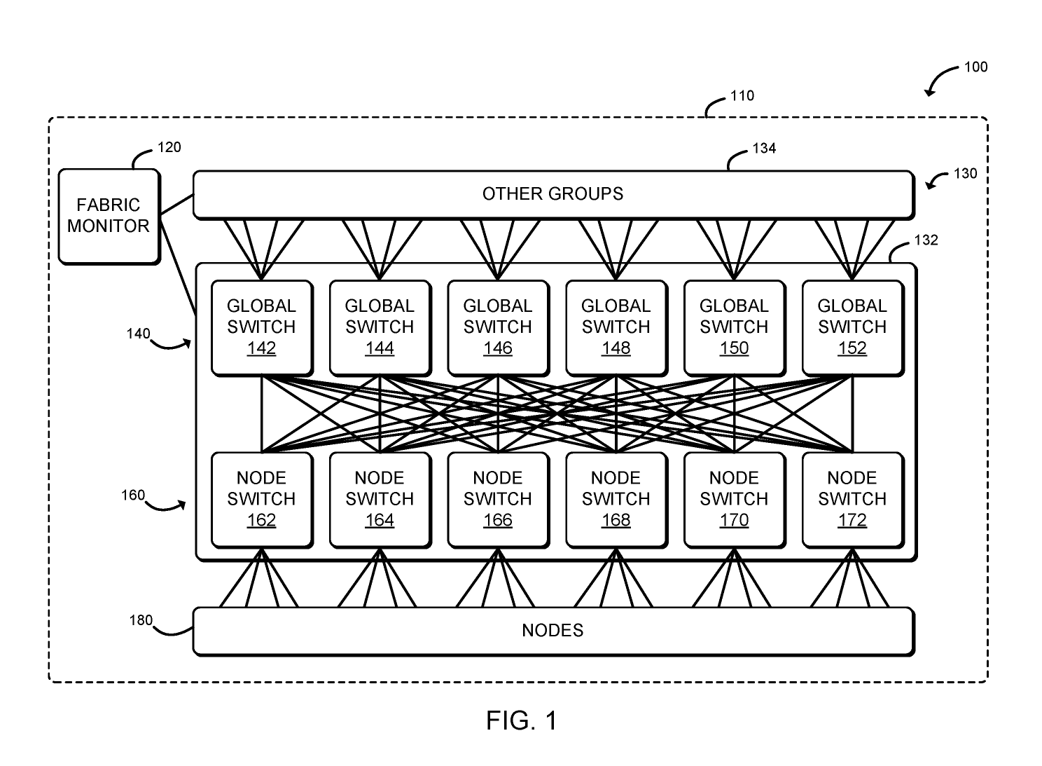

As shown in FIG. 1, an illustrative system 100 for efficiently managing link faults between switches includes a fabric monitor 120 in communication with a set 130 of groups 132, 134 via a network 110. Each group 130, in the illustrative embodiment, includes a set of global switches 140 and a set of node switches 160 connected to the global switches 140. The global switches 140 of each group 130 (e.g., group 132) connect to corresponding global switches 140 of other groups 134. The node switches 160 within a group 130 are each connected to a set of corresponding nodes 180. The nodes 180 may be embodied as any devices capable of executing workloads, such as processes, applications, or other tasks and that, in operation, send and receive packets through the network 110. In the illustrative embodiment, the global switches 140 include global switches 142, 144, 146, 148, 150, and 152. Similarly, the node switches 160, in the illustrative embodiment, include node switches 162, 164, 166, 168, 170, and 172. While six global switches 140 and six node switches 160 are shown in FIG. 1, it should be understood that in other embodiments, each group 130 may include any number of global switches 140 and node switches 160. In some embodiments, the other groups 134 include a similar topology as the group 130. However, in other embodiments, the other groups 134 may each contain just a single switch (e.g., in a 3-level fat tree topology). In the illustrative embodiment, in operation, the global switches 140 in the group are assigned an arbitrary ordering (e.g., a sequence of identifiers) in a set of routing rules. In the illustrative embodiment, the ordering defines two directions, referred to herein as earlier and later, and includes a first position and a last position. For example, the ordering may be a sequence of numbers, letters, or other identifiers that are sorted from first to last based on any sorting rule (e.g., ascending order, descending order, etc.). If an incoming packet is received by a global switch 140 and is destined for a node 180 connected to a node switch 160 where the link between the global switch 140 and the node switch 160 has failed, then the global switch 140 sends the packet to a different node switch 160 in the group 130. In response, the receiving node switch 160 determines the position of the global switch 140 in the ordering and forwards the packet to a different global switch 140 having a “later” position in the ordering. Given that all of the switches 140, 160 within the group 130 follow the same routing rules (e.g., the ordering), the switches 140, 160 avoid forming routing cycles and thereby efficiently avoid deadlock conditions without dropping packets or relying on virtual channels. The fabric monitor 120, in the illustrative embodiment, manages the ordering of the global switches 140 within each group 130 and sends the routing rules including the ordering of the global switches 140 in the groups 130. As links (e.g., downlinks) between global switches 140 and node switches 160 experience faults, the fabric monitor 120, in the illustrative embodiment, adjusts the ordering to move global switches 140 having more failed downlinks to positions earlier in the ordering and global switches 140 having more operating downlinks to later positions in the ordering, and sends the adjustments in the ordering to the corresponding groups 130.

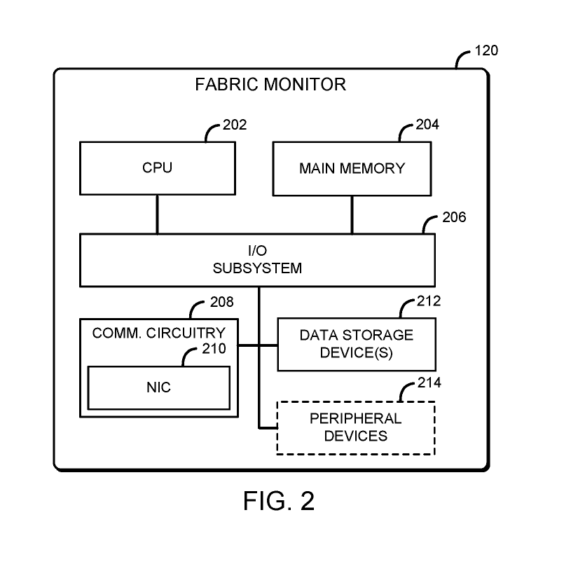

Referring now to FIG. 2, the fabric monitor 120 may be embodied as any type of compute device capable of performing the functions described herein, including generate routing rules indicative of an ordering of the global switches 140 in each group 130, monitoring the status of links between the global switches 140 and the node switches 160 to determine whether one or more downlinks have failed in the corresponding group 130, adjusting, in response to a determination that one or more downlinks have failed in the group 130, the ordering of the global switches 140 in the routing rules, and sending the adjusted routing rules to the group 130. As shown in FIG. 2, the illustrative fabric monitor 120 includes a central processing unit (CPU) 202, a main memory 204, an input/output (I/O) subsystem 206, communication circuitry 208, and one or more data storage devices 212. Of course, in other embodiments, the fabric monitor 120 may include other or additional components, such as those commonly found in a computer (e.g., display, peripheral devices, etc.). Additionally, in some embodiments, one or more of the illustrative components may be incorporated in, or otherwise form a portion of, another component. For example, in some embodiments, the main memory 204, or portions thereof, may be incorporated in the CPU 202.

The CPU 202 may be embodied as any type of processor capable of performing the functions described herein. The CPU 202 may be embodied as a single or multi-core processor(s), a microcontroller, or other processor or processing/controlling circuit. In some embodiments, the CPU 202 may be embodied as, include, or be coupled to a field programmable gate array (FPGA), an application specific integrated circuit (ASIC), reconfigurable hardware or hardware circuitry, or other specialized hardware to facilitate performance of the functions described herein. Similarly, the main memory 204 may be embodied as any type of volatile (e.g., dynamic random access memory (DRAM), etc.) or non-volatile memory or data storage capable of performing the functions described herein. In some embodiments, all or a portion of the main memory 204 may be integrated into the CPU 202. In operation, the main memory 204 may store various software and data used during operation such as status data, routing rules, applications, programs, libraries, and drivers.

The I/O subsystem 206 may be embodied as circuitry and/or components to facilitate input/output operations with the CPU 202, the main memory 204, and other components of the fabric monitor 120. For example, the I/O subsystem 206 may be embodied as, or otherwise include, memory controller hubs, input/output control hubs, integrated sensor hubs, firmware devices, communication links (e.g., point-to-point links, bus links, wires, cables, light guides, printed circuit board traces, etc.), and/or other components and subsystems to facilitate the input/output operations. In some embodiments, the I/O subsystem 206 may form a portion of a system-on-a-chip (SoC) and be incorporated, along with one or more of the CPU 202, the main memory 204, and other components of the fabric monitor 120, on a single integrated circuit chip.

The communication circuitry 208 may be embodied as any communication circuit, device, or collection thereof, capable of enabling communications over the network 110 between the fabric monitor 120 and another device (e.g., a global switch 140 or node switch 160). The communication circuitry 208 may be configured to use any one or more communication technology (e.g., wired or wireless communications) and associated protocols (e.g., Ethernet, Bluetooth®, Wi-Fi®, WiMAX, etc.) to effect such communication.

The illustrative communication circuitry 208 includes a network interface controller (NIC) 210, which may also be referred to as a host fabric interface (HFI). The communication circuitry 208 may be located on silicon separate from the CPU 202, or the communication circuitry 208 may be included in a multi-chip package with the CPU 202, or even on the same die as the CPU 202. The NIC 210 may be embodied as one or more add-in-boards, daughtercards, network interface cards, controller chips, chipsets, specialized components such as a field programmable gate array (FPGA) or application specific integrated circuit (ASIC), or other devices that may be used by the fabric monitor 120 to connect with another device (e.g., a global switch 140 or node switch 160) and communicate data. In some embodiments, NIC 210 may be embodied as part of a system-on-a-chip (SoC) that includes one or more processors, or included on a multichip package that also contains one or more processors. In some embodiments, the NIC 210 may include a local processor (not shown) and/or a local memory (not shown) that are both local to the NIC 210. In such embodiments, the local processor of the NIC 210 may be capable of performing one or more of the functions of the CPU 202 described herein. Additionally or alternatively, in such embodiments, the local memory of the NIC 210 may be integrated into one or more components of the fabric monitor 120 at the board level, socket level, chip level, and/or other levels.

The one or more illustrative data storage devices 212 may be embodied as any type of devices configured for short-term or long-term storage of data such as, for example, memory devices and circuits, memory cards, hard disk drives, solid-state drives, or other data storage devices. Each data storage device 212 may include a system partition that stores data and firmware code for the data storage device 212. Each data storage device 212 may also include an operating system partition that stores data files and executables for an operating system.

Additionally, the fabric monitor 120 may include one or more peripheral devices 214. Such peripheral devices 214 may include any type of peripheral device commonly found in a compute device such as a display, speakers, a mouse, a keyboard, and/or other input/output devices, interface devices, and/or other peripheral devices.

The global switches 140, node switches 160, and nodes 180 may have components similar to those described in FIG. 2. The description of those components are equally applicable to the description of components of the fabric monitor 120 and is not repeated herein for clarity of the description, with the exception that in the global switches 140 and node switches 160, the communication circuitry 208 includes port logics to connect each switch 140, 160 with multiple other switches 140, 160 and/or other devices (e.g., nodes 180). Further, it should be appreciated that the global switches 140, node switches 160, and/or nodes 180 may include other components, sub-components, and devices commonly found in a computing device, which are not discussed above in reference to the fabric monitor 120 and not discussed herein for clarity of the description.

As described above, the fabric monitor 120, global switches 140, node switches 160, and nodes 180 are illustratively in communication via the network 110, which may be embodied as any type of wired or wireless communication network, including a fabric having a 3-level fat tree topology or other large scale indirect topology, one or more local area networks (LANs) or wide area networks (WANs), cellular networks (e.g., Global System for Mobile Communications (GSM), 3G, Long Term Evolution (LTE), Worldwide Interoperability for Microwave Access (WiMAX), etc.), digital subscriber line (DSL) networks, cable networks (e.g., coaxial networks, fiber networks, etc.), global networks (e.g., the Internet), or any combination thereof.

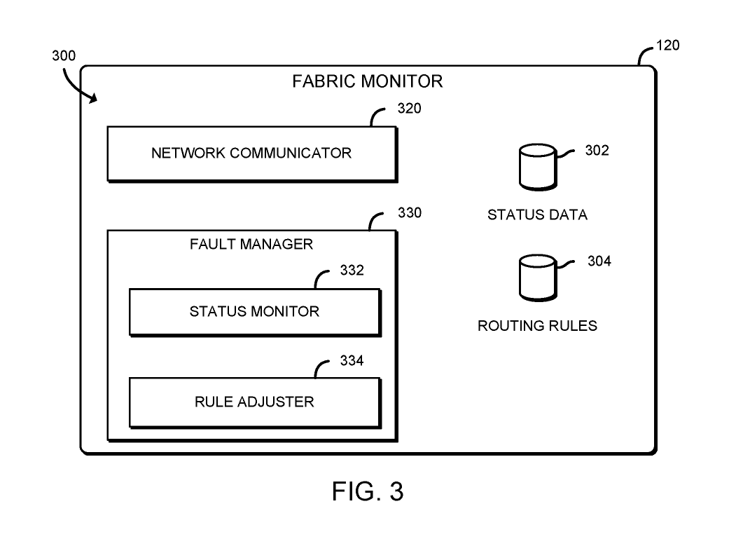

Referring now to FIG. 3, in the illustrative embodiment, the fabric monitor 120 may establish an environment 300 during operation. The illustrative environment 300 includes a network communicator 320 and a fault manager 330. Each of the components of the environment 300 may be embodied as hardware, firmware, software, or a combination thereof. As such, in some embodiments, one or more of the components of the environment 300 may be embodied as circuitry or a collection of electrical devices (e.g., network communicator circuitry 320, fault manager circuitry 330, etc.). It should be appreciated that, in such embodiments, one or more of the network communicator circuitry 320 or fault manager circuitry 330 may form a portion of one or more of the communication circuitry 208, the CPU 202, the main memory 204, the I/O subsystem 206, and/or other components of the fabric monitor 120. In the illustrative embodiment, the environment 300 includes status data 302 which may be embodied as any data indicative of whether each link between the global switches 140 and node switches 160 are operational or not (e.g., failed). In the illustrative embodiment, the status data 302 indicates whether links (“downlinks”) for sending packets from global switches 140 to node switches 160 are operational or not. The status data 302 may be collected from the switches 140, 160 in each group 130 (e.g., reported by the global switches 140 and/or the node switches 160 in each group 130), as explained in more detail herein. Additionally, in the illustrative embodiment, the environment 300 includes routing rules 304 which may be embodied as any data indicative of an assigned ordering of the global switches 140 in each group 130. In the illustrative embodiment, the fabric monitor 120 determines and continually readjusts the ordering in response to changes in the status data 302, as described in more detail herein.

In the illustrative environment 300, the network communicator 320, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the fabric monitor 120, respectively. To do so, the network communicator 320 is configured to receive and process packets from one or more devices (e.g., one or more switches 140, 160) and to prepare and send packets to one or more devices (e.g., one or more switches 140, 160). Accordingly, in some embodiments, at least a portion of the functionality of the network communicator 320 may be performed by the communication circuitry 208, and, in the illustrative embodiment, by the HFI 210.

The fault manager 330, which may be embodied as hardware, firmware, software, virtualized hardware, emulated architecture, and/or a combination thereof as discussed above, is configured to obtain the status data 302 and determine and continually adjust the routing rules 304 as a function of the status data 302. To do so, in the illustrative embodiment, the fault manager 330 includes a status monitor 332 and a rule adjuster 334. The status monitor 332, in the illustrative embodiment, is configured to receive updates on the status of the links (e.g., the downlinks) between the global switches 140 and the node switches 160 in each group 130. The status monitor 332 may poll one or more switches 140, 160 in each group for updated status data 302 on a periodic basis or may passively receive updates (e.g., on a periodic basis, in response to detections of changes in link status by one or more global switches 140, etc.). The rule adjuster 334, in the illustrative embodiment, is configured to determine and readjust the routing rules 304 as a function of the status data 302. Initially, the rule adjuster may 334 assign an arbitrary ordering to the global switches 140 in each group 130 and, subsequently, as the status monitor 332 obtains updated status data 302, the rule adjuster 334 may adjust the ordering of the global switches 140 in the routing rules 304 to assign global switches 140 having relatively more failed downlinks to positions that are earlier in the ordering and assign global switches 140 having relatively fewer failed downlinks to positions that are later in the ordering. In the illustrative embodiment, the rule adjuster 334 moves a global switch 140 having no failed downlinks to the last position in the ordering for the corresponding group 130, such that, if the node switches 160 in a group 130 ultimately forward a packet to the last global switch 140 in the ordering, the last global switch 140 will be able to redirect the packet to the appropriate node switch 160 (e.g., the node switch 160 connected to the node 180 to which the packet is addressed).

It should be appreciated that each of the status monitor 332 and the rule adjuster 334 may be separately embodied as hardware, firmware, software, virtualized hardware, emulated architecture, and/or a combination thereof. For example, the status monitor 332 may be embodied as a hardware component, while the rule adjuster 334 is embodied as a virtualized hardware component or as some other combination of hardware, firmware, software, virtualized hardware, emulated architecture, and/or a combination thereof.

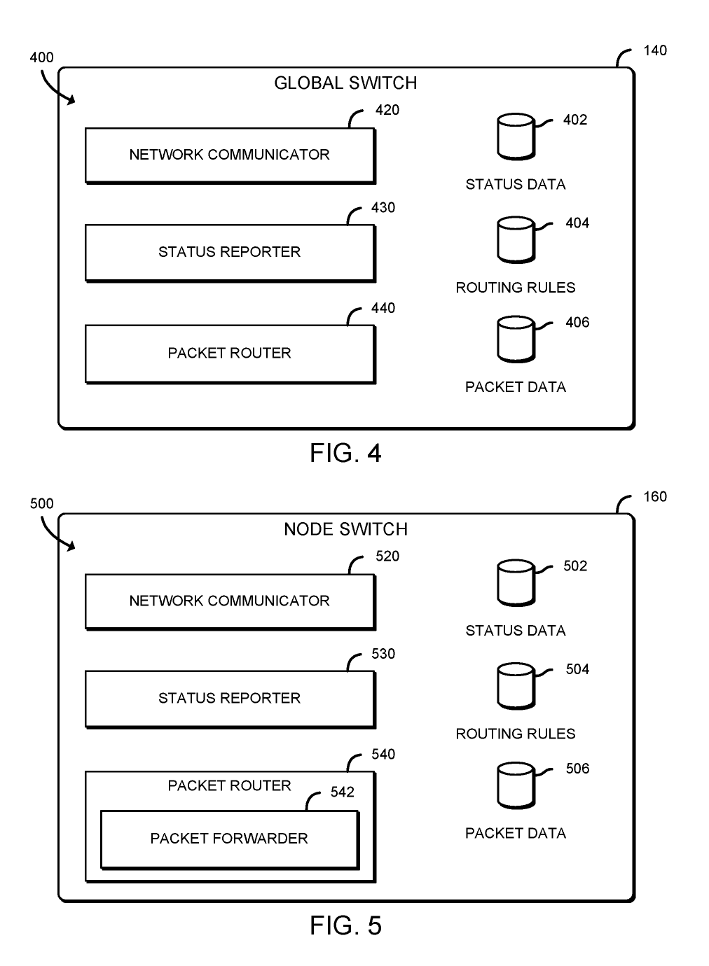

Referring now to FIG. 4, in the illustrative embodiment, each global switch 140 may establish an environment 400 during operation. The illustrative environment 400 includes a network communicator 420, a status reporter 430, and a packet router 440. Each of the components of the environment 400 may be embodied as hardware, firmware, software, or a combination thereof. As such, in some embodiments, one or more of the components of the environment 400 may be embodied as circuitry or a collection of electrical devices (e.g., network communicator circuitry 420, status reporter circuitry 430, packet router circuitry 440, etc.). It should be appreciated that, in such embodiments, one or more of the network communicator circuitry 420, status reporter circuitry 430, or packet router circuitry 440 may form a portion of one or more of the communication circuitry 208, the CPU 202, the main memory 204, the I/O subsystem 206, and/or other components of the global switch 140. In the illustrative embodiment, the environment 400 includes status data 402, similar to the status data 302, except the status data 402 is indicative of the status (e.g., failed or operative) of links between the present global switch 140 and the node switches 160 in the present group 130 (e.g., the group 130 that the global switch 140 is included in), rather than the status of links between all of the global switches 140 and node switches 160 in the network 110. Additionally, in the illustrative embodiment, the environment includes routing rules 404, similar to the routing rules 304, except the routing rules 404 are indicative of the ordering of global switches 140 within the group 130 that the present global switch 140 is included in, rather than the ordering of global switches 140 in multiple groups 130 in the network 110. The illustrative environment 400 also includes packet data 406, which may be embodied as any data indicative of packets to be routed to a node 180 in the group 130 or from a node 180 in the group 130 to another group 130. In the illustrative embodiment, the packet data 406 includes an identification of the destination node 180 to which each packet is to be routed and a corresponding payload (e.g., data) to be provided to the destination node 180.

In the illustrative environment 400, the network communicator 420, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the global switch 140, respectively. To do so, the network communicator 420 is configured to receive and process packets from one or more devices (e.g., one or more switches 140, 160 and/or the fabric monitor 120) and to prepare and send packets to one or more devices (e.g., one or more switches 140, 160 and/or the fabric monitor 120). Accordingly, in some embodiments, at least a portion of the functionality of the network communicator 420 may be performed by the communication circuitry 208 (e.g., by one or more port logics).

The status reporter 430, which may be embodied as hardware, firmware, software, virtualized hardware, emulated architecture, and/or a combination thereof as discussed above, is configured to continually determine the status of links (e.g., downlinks) between the present global switch 140 and the node switches 160 in the present group 130 and report the status (e.g., the status data 402) to the fabric monitor 120. The status reporter 430 may determine that a particular downlink has failed if one or other threshold number of packets are unsuccessfully delivered to the corresponding node switch 160 and/or if a physical layer error is detected (e.g., by the communication circuitry 208), such as a detection that the physical connection (e.g., copper wiring, optical fiber, etc.) has become severed or otherwise disconnected. The status reporter 430 may send the status data 402 periodically (e.g., regardless of whether a change in the status of any links has been detected since the previous report) or in response to a change in the status of one or more links (e.g., detection of a newly failed downlink or detection that a downlink has become operative again, such as due to maintenance performed by a technician).

The packet router 440, which may be embodied as hardware, firmware, software, virtualized hardware, emulated architecture, and/or a combination thereof as discussed above, is configured to receive a packet (e.g., from a source, such as a global switch 140, external to the present group 130, or from a source, such as a node switch 160, internal to the group 130) and route the packet towards its destination, based on destination address data associated with (e.g., included in) the packet. In the illustrative embodiment, if a received packet is addressed to a node 180 within the present group 130, the packet router 440 determines whether the downlink to the node switch 160 connected to the destination node 180 is operating (e.g., has not failed). If so, the packet router 440 determines to send the packet through the corresponding downlink. Otherwise, the packet router 440 determines to send the packet through an operating downlink to a different node switch 160 in the present group 130. As described in more detail herein, in the illustrative embodiment, the receiving node switch 160 will forward the packet to another global switch 140 that has a later position in the ordering as compared to the present global switch 140.

Referring now to FIG. 5, in the illustrative embodiment, each node switch 160 may establish an environment 500 during operation. The illustrative environment 500 includes a network communicator 520, a status reporter 530, and a packet router 540. Each of the components of the environment 500 may be embodied as hardware, firmware, software, or a combination thereof. As such, in some embodiments, one or more of the components of the environment 500 may be embodied as circuitry or a collection of electrical devices (e.g., network communicator circuitry 520, status reporter circuitry 530, packet router circuitry 540, etc.). It should be appreciated that, in such embodiments, one or more of the network communicator circuitry 520, status reporter circuitry 530, or packet router circuitry 540 may form a portion of one or more of the communication circuitry 208, the CPU 202, the main memory 204, the I/O subsystem 206, and/or other components of the node switch 160. In the illustrative embodiment, the environment 500 includes status data 502, similar to the status data 402, except the status data 502 is indicative of the status of links (e.g., downlinks and uplinks) between the present node switch 160 and the global switches 140 in the present group 130. The status of each link may be that the link is operative or inoperative (e.g., failed). Additionally, in the case of an uplink, the status data 502 may additionally indicate whether the uplink is dedicated to forwarding inbound packets from one or more global switches 140 to another global switch 140, pursuant to the routing rules. The illustrative embodiment 500 additionally includes routing rules 504, which may be embodied as any data indicative of the ordering of global switches 140 within the group 130 that the present node switch 160 is included in. As such, in the illustrative embodiment, the routing rules 504 are similar to the routing rules 404 of FIG. 4. The illustrative environment 500 additionally includes packet data 506, which may be embodied as any data indicative of packets to be routed to a node 180 in the group 130 or from a node 180 in the group 130 to another group 130. As such, the packet data 506 is similar to the packet data 406 of FIG. 4.

In the illustrative environment 500, the network communicator 520, which may be embodied as hardware, firmware, software, virtualized hardware, emulated architecture, and/or a combination thereof as discussed above, is configured to facilitate inbound and outbound network communications (e.g., network traffic, network packets, network flows, etc.) to and from the node switch 160, respectively. To do so, the network communicator 520 is configured to receive and process packets from one or more devices (e.g., one or more nodes 180 and/or one or more global switches 140) and to prepare and send packets to one or more devices (e.g., one or more nodes 180 and/or one or more global switches 140). Accordingly, in some embodiments, at least a portion of the functionality of the network communicator 520 may be performed by the communication circuitry 208 (e.g., by one or more port logics).

The status reporter 530, which may be embodied as hardware, firmware, software, virtualized hardware, emulated architecture, and/or a combination thereof as discussed above, is configured to continually determine the status of links between the present node switch 160 and the global switches 140 in the present group 130 and report the status (e.g., the status data 502) to the fabric monitor 120. The status reporter 530 may determine that a particular link has failed if one or other threshold number of packets are unsuccessfully delivered to or from the corresponding global switch 140 and/or if a physical layer error is detected (e.g., by the communication circuitry 208), such as a detection that the physical connection (e.g., copper wiring, optical fiber, etc.) has become severed or otherwise disconnected. The status reporter 530 may send the status data 502 periodically (e.g., regardless of whether a change in the status of any links has been detected since the previous report) or in response to a change in the status of one or more links (e.g., detection of a newly failed link or detection that a link has become operative again, such as due to maintenance performed by a technician).

The packet router 540, which may be embodied as hardware, firmware, software, virtualized hardware, emulated architecture, and/or a combination thereof as discussed above, is configured to receive a packet from a global switch 140 or from a node 180 in the present group 130 and route the packet towards its destination (e.g., to the destination node 180 or out of the present group 130 via a global switch 140). Furthermore, the packet router 540, in the illustrative embodiment, is configured to forward packets from one global switch 140 in the present group 130 to another global switch 140 in the present group 130 to compensate for a failed downlink. To do so, in the illustrative embodiment, the packet router 540 includes a packet forwarder 542. In the illustrative embodiment, the packet forwarder 542 is configured to determine whether a received packet from a global switch 140 in the present group 130 is to be forwarded to another global switch 140 in the present group 130. The packet forwarder 542 may do so by analyzing address data in the packet to determine whether the packet is addressed to a node 180 that is connected to the present node switch 160 and/or by receiving a request (e.g., included with the packet or received separately from the global switch 140) to forward the packet. In response to a determination that the packet is to be forwarded, the packet forwarder determines the position of the global switch 140 that sent the packet in the ordering indicated in the routing rules 504 (e.g., by comparing an internet protocol address, a media access control (MAC) address, or other identifier of the global switch 140 to an identifier of its position in the routing rules 504) and selects another global switch 140 at a later position in the ordering to send the packet to. Additionally, in the illustrative embodiment, the packet forwarder 542 is configured to dedicate the uplink between the present node switch 160 and the selected global switch 140 for forwarding packets. As such, the dedicate uplink may not be used to route nodes originating from nodes 180 connected to the present node switch 160. Rather, the packet router 540 utilizes a different uplink (e.g., to any other global switch 140 in the present group 130) to send outgoing packets.

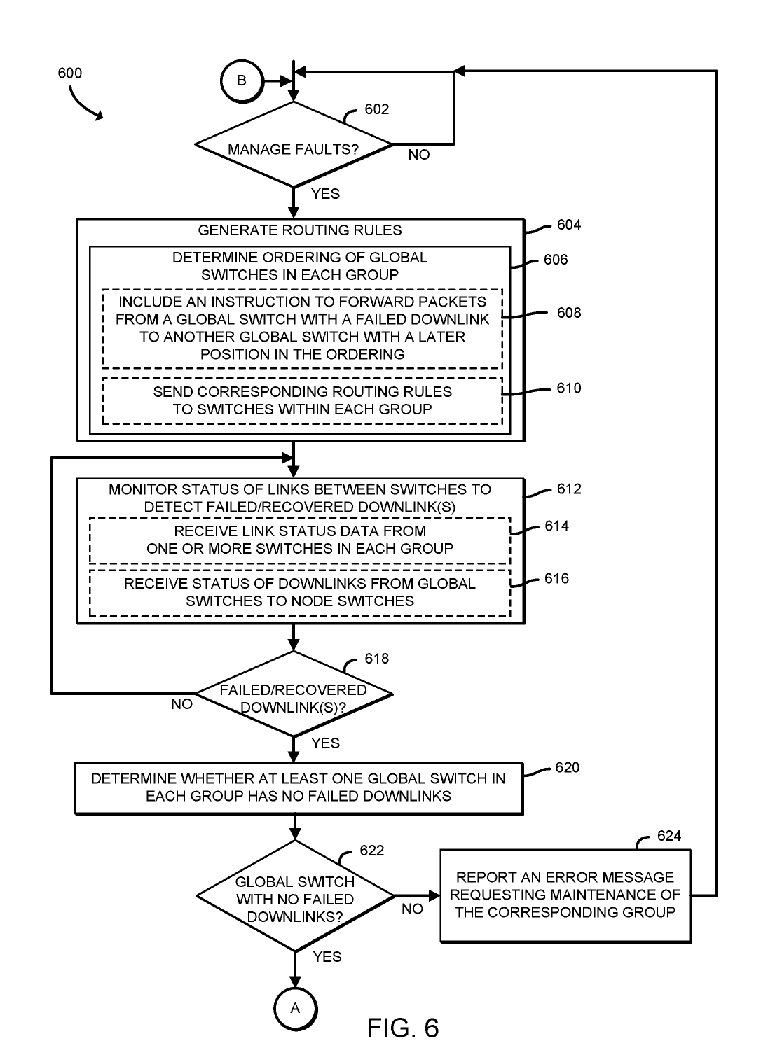

Referring now to FIG. 6, in use, the fabric monitor 120 may execute a method 600 for managing link faults. The method 600 begins with block 602, in which the fabric monitor 120 determines whether to manage link faults. In the illustrative embodiment, the fabric monitor 120 determines to manage link faults if the fabric monitor 120 is powered on and in communication with one or more groups 130 (e.g., in communication with switches 140, 160 in one or more groups 130). In other embodiments, the fabric monitor 120 may determine whether to manage link faults based on other criteria. Regardless, in response to a determination to manage link faults, the method 600 advances to block 604, in which the fabric monitor 120 generates routing rules (e.g., the routing rules 304). In doing so, in the illustrative embodiment, the fabric monitor 120 determines an ordering of the global switches 140 in each group 130, as indicated in block 606. As indicated in block 608, the fabric monitor 120 may include an instruction in the routing rules 304 to forward packets from a global switch 140 to another global switch 140 assigned to a later position in the ordering (i.e., a “later global switch”) if the earlier global switch 140 (e.g., the global switch 140 that sent the packet) has a failed downlink. In the illustrative embodiment, the fabric monitor 120 sends the routing rules to the switches (e.g., global switches 140 and/or node switches 160) in the corresponding groups 130, as indicated in block 610.

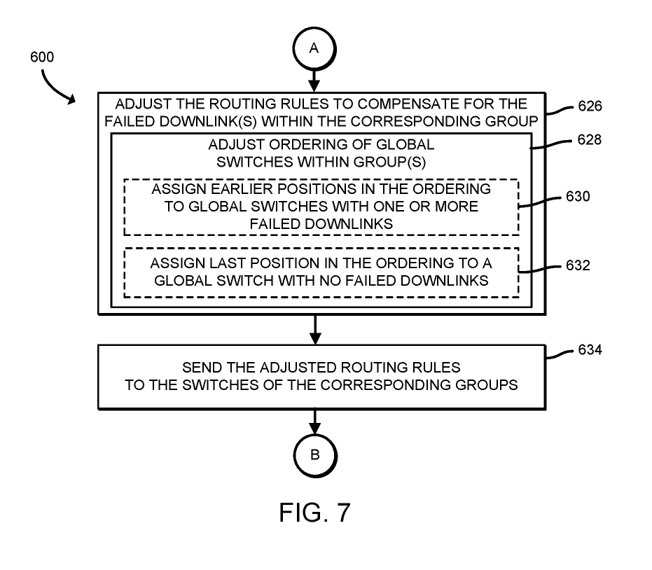

Subsequently, the method 600 advances to block 612 in which the fabric monitor 120 monitors the status of links between the switches (e.g., global switches 140 and node switches 160) in each group 130 to detect failed downlinks and any downlinks that have recovered (e.g., previously failed and have been repaired). In doing so, the fabric monitor 120 may receive link status data (e.g., the status data 302) from one or more switches (e.g., global switches 140 and/or node switches 160) in each group 130, as indicated in block 614. In the illustrative embodiment, the fabric monitor 120 receives the status of downlinks from the global switches 140 to the node switches 160 in each group 130, as indicated in block 616. In block 618, the fabric monitor 120 determines the next operations based on whether failed downlinks and/or recovered downlinks were detected in block 612. In response to a determination that no failed or recovered downlinks were detected, the method 600 loops back to block 612 to again monitor the status of the links to detect one or more failed or recovered downlinks. Otherwise, the method 600 advances to block 620, in which the fabric monitor 120 determines whether at least one global switch 140 in each group 130 has no failed downlinks (e.g., each group 130 includes at least one global switch 140 for which all of the downlinks are operating). In block 622, the fabric monitor 120 determines a next course of action based on whether there is at least one global switch 140 that has no failed downlinks in each group 130. In response to a determination that there is not a global switch 140 with no failed downlinks in each group 130, the method 600 advances to block 624 in which the fabric monitor 120 reports an error message (e.g., to an administrator server (not shown), on a user interface, etc.) requesting maintenance of the one or more groups 130 in which each global switch 140 has at least one failed downlink. Subsequently, the method 600 loops back to block 602 to determine whether to continue managing faults. Otherwise, the method 600 advances to block 626 of FIG. 7, in which the fabric monitor 120 adjusts the routing rules based on the status of the downlinks, such as to compensate for failed downlink(s) within the corresponding group(s) 130.

Referring now to FIG. 7, and as indicated in block 628, in adjusting the routing rules 304, the fabric monitor 120, in the illustrative embodiment, adjusts the ordering of the global switches 140 within the groups 130 in which failed downlinks were detected in block 612. In doing so, in the illustrative embodiment, the fabric monitor 120 assigns earlier positions in the ordering to global switches 140 with one or more failed downlinks, as indicated in block 630. Further, in the illustrative embodiment, the fabric monitor 120 assigns the last position in the ordering to a global switch 140 with no failed downlinks, as indicated in block 632. As an example, if the fabric monitor 120 determines that a global switch 140 at the last position in the ordering (e.g., position six in a group of six global switches 140) has a failed downlink, the fabric monitor 120 may reassign the global switch 140 to the earliest position (e.g., position one) and reassign another global switch 140 that has no failed downlinks to the last position (e.g., position six). Subsequently, in block 634, the fabric monitor 120 sends the adjusted routing rules to the switches (e.g., the global switches 140 and/or the node switches 160) of the corresponding groups 130 (e.g., the groups 130 for which the routing rules 304 were adjusted). Afterwards, the method 600 loops back to block 602 of FIG. 6, in which the fabric monitor 120 again determines whether to manage faults.

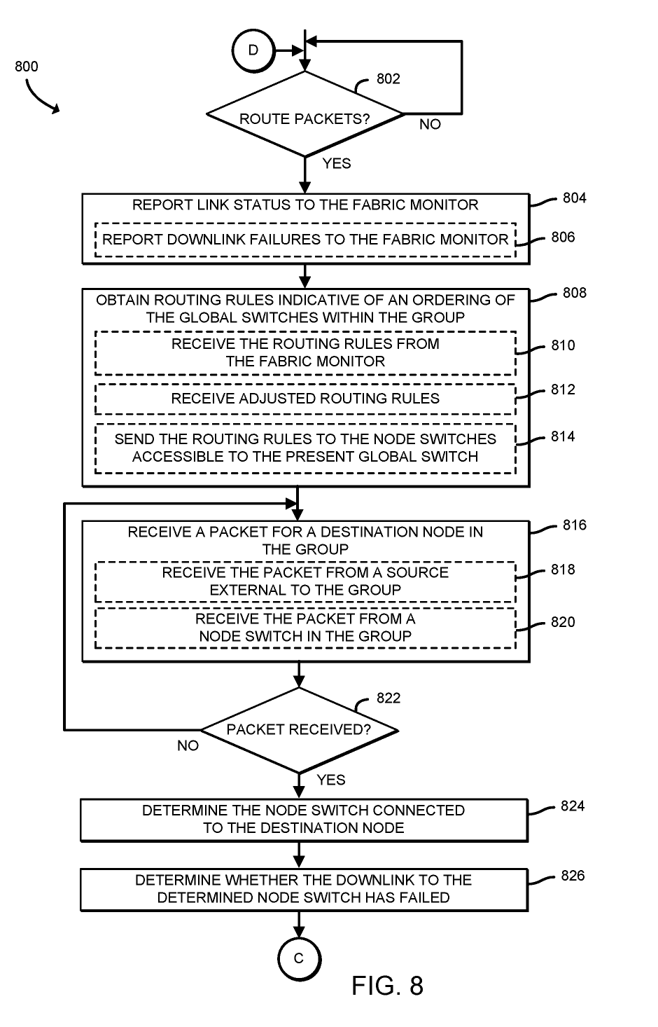

Referring now to FIG. 8, in use each global switch 140 may execute a method 800 for routing packets. The method 800 begins with block 802 in which the global switch 140 determines whether to route packets. In the illustrative embodiment, the global switch 140 determines to route packets if the global switch 140 is powered on and in communication with one or more other devices (e.g., the fabric monitor 120, global switches 140 from other groups, node switches 160 within the group 130, etc.). In other embodiments, the global switch 140 may determine whether to route packets based on other criteria. Regardless, in response to a determination to route packets, the method 800 advances to block 804 in which the global switch 140 reports link status (e.g., the status data 402) to the fabric monitor 120. It should be understood that, in the illustrative embodiment, the global switch 140 continually updates the status data 402 while the global switch 140 is operating. In the illustrative embodiment, in reporting the link status, the global switch 140 reports downlink failures to the fabric monitor 120, as indicated in block 806.

In block 808, the global switch 140 obtains routing rules (e.g., the routing rules 404) indicative of an ordering of the global switches 140 within the group 130. In doing so, in the illustrative embodiment, the global switch 140 receives the routing rules 404 from the fabric monitor 120, as indicated in block 810. In receiving the routing rules 404, the global switch 140 may receive adjusted routing rules (e.g., the routing rules 404 were adjusted by the fabric monitor 120 at least once, as described with reference to blocks 626 and 634 of FIG. 7), as indicated in block 812. In the illustrative embodiment, the global switch 140 sends the routing rules 404 to the node switches 160 that are accessible to the global switch 140 (e.g., accessible through working downlinks), as indicated in block 814. Subsequently, in block 816, the global switch 140 receives a packet for a destination node 180 in the present group 130. In doing so, the global switch 140 may receive the packet from a source external to the present group 130 (e.g., from a global switch 140 of another group 130), as indicated in block 818. Alternatively, the global switch 140 may receive the packet from a node switch 160 within the present group 130 (e.g., a packet that was received by a different global switch 140 in the group 130 and is being forwarded by the node switch 160), as indicated in block 820.

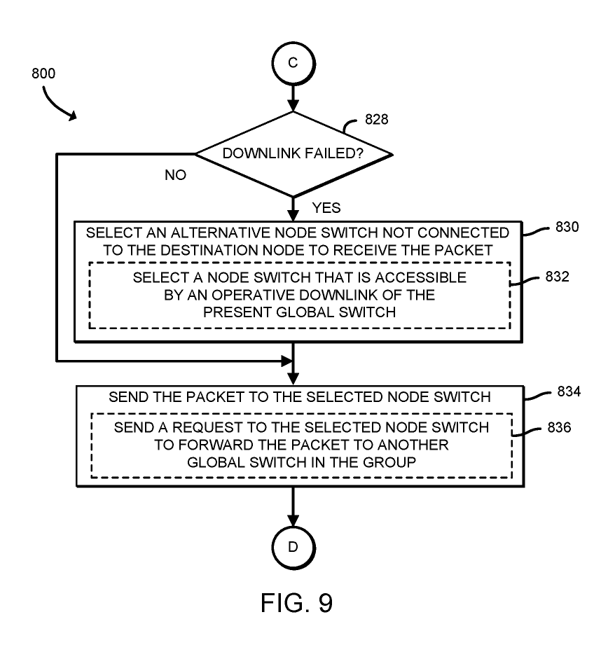

In block 822, the global switch 140 determines the subsequent course of action based on whether a packet was received in block 816. If a packet was not received, the method 800 loops back to block 816 in which the global switch 140 awaits a packet. Otherwise, the method 800 advances to block 824, in which the global switch 140 determines the corresponding node switch 160 connected to the destination node 180, such as by analyzing an address (e.g., internet protocol address, media access control address, etc.) of the destination node 180 from a section of the packet and referencing a routing table that associates destination node addresses to node switches 160. In block 826, the global switch 140 determines whether the downlink to the determined node switch 160 has failed (e.g., as indicated in the status data 402). Subsequently, the method 800 advances to block 828 of FIG. 9, in which the global switch 140 determines the subsequent operations based on whether the downlink to the determined node switch 160 has failed. If the downlink has failed, the method 800 advances to block 830 in which the global switch 140 selects an alternative node switch that is not connected to the destination node 180 to receive the packet for forwarding to another global switch 140 in the group 130. In doing so, the global switch 140 selects a node switch 160 that is accessible to the present global switch 140 through an operative (e.g. non-failed) downlink, as indicated in block 832. Subsequently, or if the global switch 140 determined in block 828 that the downlink has not failed, the method 800 advances to block 834 in which the global switch 140 sends the packet to the node switch 160 (e.g., the node switch 160 connected to the destination node 180 or another node switch 160 that is accessible to the global switch 140 and is to forward the packet to another global switch 140 in the group 130). In doing so, as indicated in block 836, the global switch 140 may send a request to the selected node switch 160 to forward the packet to another global switch 140 in the group 130 (e.g., if the node switch 160 is not connected to the destination node 180). Subsequently, the method 800 loops back to block 802 of FIG. 8, in which the global switch 140 determines whether to continue routing packets.

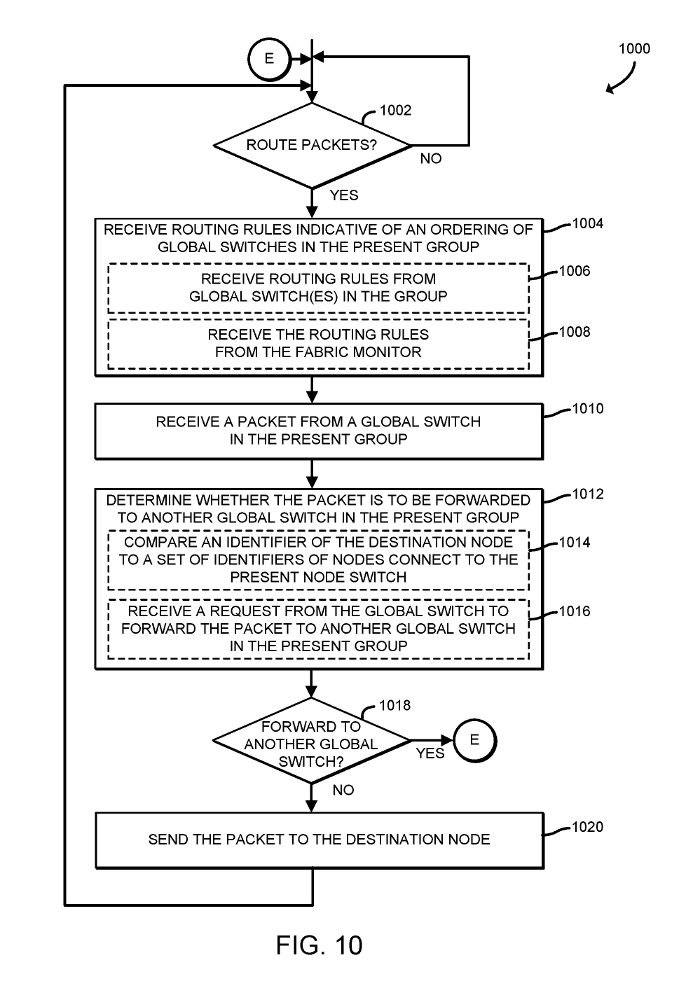

Referring now to FIG. 10, in use, each node switch 160 may execute a method 1000 for routing packets. The method 1000 begins with block 1002, in which the node switch 160 determines whether to route packets. In the illustrative embodiment, the node switch 160 determines to route packets if the node switch is powered on and is in communication with one or more other devices (e.g., the fabric monitor 120, one or more global switches 140 within the present group 130, one or more nodes 180, etc.). In other embodiments, the node switch 160 may determine to route packets based on other criteria. Regardless, in response to a determination to route packets, the method 1000 advances to block 1004, in which the node switch 160 receives routing rules (e.g., the routing rules 504) indicative of an ordering of the global switches 140 in the present group 130. In doing so, the node switch 160 may receive the routing rules 504 from one or more global switches 140 in the present group, as indicated in block 1006. Additionally or alternatively, the node switch 160 may receive the routing rules 504 from the fabric monitor 120, as indicated in block 1008.

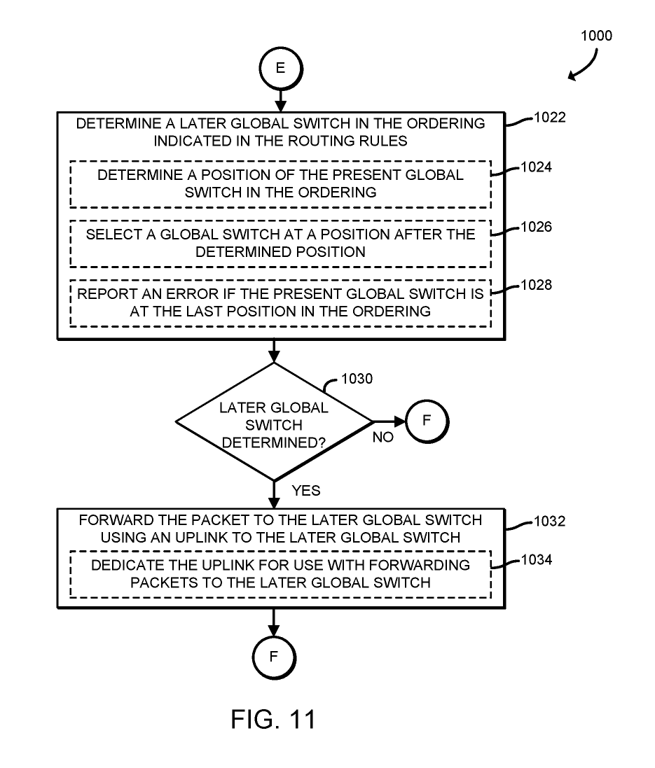

Subsequently, in block 1010, the node switch 160 receives a packet from a global switch 140 in the present group 130. It should be understood that the node switch 160 may also receive packets from the nodes 180 connected to the node switch 160 and route them out of the group 130 through a global switch 140. The routing outgoing packets by the node switch 160 is not discussed in more detail herein, as that function is not affected by the link fault management scheme described herein, with the exception that an uplink between the node switch 160 and a global switch 140 may become dedicated to forwarding packets, as described in association with block 1034 of FIG. 11. In block 1012, the node switch 160 determines whether the packet received from a global switch 140 is to be forwarded to another global switch 140 in the present group 130. In doing so, the node switch 160 may compare an identifier (e.g., an address such as an internet protocol address, a media access control address, etc.) of the destination node 180 for the packet (e.g., indicated in a section of packet) to a set of identifiers (e.g., internet protocol addresses, media access control addresses, etc.) connected to the node switch 160, as indicated in block 1014. Additionally or alternatively, the node switch 160 may receive a request from the global switch 140 to forward the packet to another global switch 140 in the present group 130, as indicated in block 1016. The request may be received separately or may be embodied as an indicator (e.g., a flag) in the packet.

In block 1018, the node switch 160 determines the subsequent operations to perform based on whether the node switch 160 determined to forward the packet to another global switch 140 in the present group 130. If the packet is not to be forwarded to another global switch 140, the method 1000 advances to block 1020, in which the node switch 160 sends the packet to the destination node 180. Otherwise, the method 1000 advances to block 1022 of FIG. 11, in which the node switch 160 determines a later global switch 140 in the ordering indicated in the routing rules 504.

Referring now to FIG. 11, in determining a later global switch in the ordering, the node switch 160, in the illustrative embodiment, determines the position of the present global switch 140 (e.g., the global switch 140 that sent the packet to the node switch 160) in the ordering, as indicated in block 1024 and selects a global switch 140 at a position that is after the determined position in the ordering (i.e., a “later global switch”), as indicated in block 1026. For example, if the node switch 160 received the packet from a global switch 140 at position two in the ordering, the node switch 160 may select a global switch 140 at position three in the ordering. As indicated in block 1028, if the present global switch 140 (e.g., the global switch 140 that sent the packet to the node switch 160) is at the last position in the ordering (e.g., the sixth position out of six global switches 140), the node switch 160 may report an error (e.g., an error requesting maintenance of the group 130). In doing so, the node switch 160 may send an error message to the fabric monitor 120, display the error on a user interface, or otherwise report the error. In block 1030, the node switch 160 determines the subsequent operations based on whether a later global switch 140 was determined in block 1022. If not (e.g., the global switch 140 that sent the packet was at the last position in the ordering), the method 1000 loops back to block 1002 of FIG. 10, in which the node switch 160 determines whether to continue routing packets. Otherwise, the method 1000 advances to block 1032, in which the node switch 160 forwards the packet to the later global switch 140 using an uplink to the later global switch 140. Further, the node switch 160 may dedicate the uplink for use only with forwarding packets to the later global switch 140, thereby making the uplink unavailable for routing outgoing packets originating from one of the nodes 180, as indicated in block 1034. Subsequently, the method 1000 loops back to block 1002, in which the node switch 160 determines whether to continue routing packets.

### EXAMPLES

Illustrative examples of the technologies disclosed herein are provided below. An embodiment of the technologies may include any one or more, and any combination of, the examples described below.

Example 1 includes a fabric monitor for efficiently managing link faults between switches, the fabric monitor comprising one or more processors; one or more memory devices having stored therein a plurality of instructions that, when executed, cause the fabric monitor to generate routing rules indicative of an ordering of a plurality of global switches connected to a plurality of node switches in a group; monitor a status of links between the global switches and the node switches to determine whether one or more downlinks have failed in the group; adjust, in response to a determination that one or more downlinks have failed in the group, the ordering of the global switches in the routing rules; and send the adjusted routing rules to the group.

Example 2 includes the subject matter of Example 1, and wherein to adjust the ordering of the global switches comprises to assign earlier positions in the ordering to global switches with one or more failed downlinks.

Example 3 includes the subject matter of any of Examples 1 and 2, and wherein to adjust the ordering further comprises to assign a last position in the order to a global switch that has no failed downlinks.

Example 4 includes the subject matter of any of Examples 1-3, and wherein to send the adjusted routing rules comprises to send the adjusted routing rules to at least one global switch or node switch in the group.

Example 5 includes the subject matter of any of Examples 1-4, and wherein, when executed, the plurality of instructions further cause the fabric monitor to send the generated routing rules to the group.

Example 6 includes the subject matter of any of Examples 1-5, and wherein to monitor the status of links between the global switches and the node switches comprises to receive link status data from one or more of the switches in the group.

Example 7 includes the subject matter of any of Examples 1-6, and wherein to monitor the status of links between global switches and node switches in the group comprises to receive data indicative of a status of downlinks from the global switches to the node switches in the group.

Example 8 includes the subject matter of any of Examples 1-7, and wherein to generate the routing rules indicative of an ordering of the global switches comprises to generate routing rules that include an instruction for one or more of the node switches to route packets received from a global switch with a failed downlink to another global switch with a later position in the ordering.

Example 9 includes the subject matter of any of Examples 1-8, and wherein, when executed, the plurality of instructions further cause the fabric monitor to determine whether the group includes at least one global switch with no failed downlinks; and report, in response to a determination that the group does not include a global switch with no failed downlinks, an error message to request maintenance of the group.

Example 10 includes the subject matter of any of Examples 1-9, and wherein to monitor the status of links between global switches and node switches comprises to monitor the status of links between global switches and node switches in multiple groups.

Example 11 includes the subject matter of any of Examples 1-10, and wherein to generate the routing rules comprises to generate routing rules for each of multiple groups of global switches and node switches.

Example 12 includes the subject matter of any of Examples 1-11, and wherein, when executed, the plurality of instructions further cause the fabric monitor to send the routing rules to each corresponding group of the multiple groups.

Example 13 includes the subject matter of any of Examples 1-12, and wherein to monitor the status of links between the global switches and the node switches comprises to receive data indicative of the status of downlinks in each of the multiple groups.

Example 14 includes the subject matter of any of Examples 1-13, and wherein to adjust the routing rules comprises to adjust the routing rules for multiple groups of global switches and node switches.

Example 15 includes a method for efficiently managing link faults between switches, the method comprising generating, by a fabric monitor, routing rules indicative of an ordering of a plurality of global switches connected to a plurality of node switches in a group; monitoring, by the fabric monitor, a status of links between the global switches and the node switches to determine whether one or more downlinks have failed in the group; adjusting, by the fabric monitor and in response to a determination that one or more downlinks have failed in the group, the ordering of the global switches in the routing rules; and sending, by the fabric monitor, the adjusted routing rules to the group.

Example 16 includes the subject matter of Example 15, and wherein adjusting the ordering of the global switches comprises assigning earlier positions in the ordering to global switches with one or more failed downlinks.

Example 17 includes the subject matter of any of Examples 15 and 16, and wherein adjusting the ordering further comprises assigning a last position in the order to a global switch that has no failed downlinks.

Example 18 includes the subject matter of any of Examples 15-17, and wherein sending the adjusted routing rules comprises to send the adjusted routing rules to at least one global switch or node switch in the group.

Example 19 includes the subject matter of any of Examples 15-18, and further including sending, by the fabric monitor, the generated routing rules to the group.

Example 20 includes the subject matter of any of Examples 15-19, and wherein monitoring the status of links between the global switches and the node switches comprises receiving link status data from one or more of the switches in the group.

Example 21 includes the subject matter of any of Examples 15-20, and wherein monitoring the status of links between global switches and node switches in the group comprises receiving data indicative of a status of downlinks from the global switches to the node switches in the group.

Example 22 includes the subject matter of any of Examples 15-21, and wherein generating the routing rules indicative of an ordering of the global switches comprises generating routing rules that include an instruction for one or more of the node switches to route packets received from a global switch with a failed downlink to another global switch with a later position in the ordering.

Example 23 includes the subject matter of any of Examples 15-22, and further including determining, by the fabric monitor, whether the group includes at least one global switch with no failed downlinks; and reporting, by the fabric monitor and in response to a determination that the group does not include a global switch with no failed downlinks, an error message to request maintenance of the group.

Example 24 includes the subject matter of any of Examples 15-23, and wherein monitoring the status of links between global switches and node switches comprises monitoring the status of links between global switches and node switches in multiple groups.

Example 25 includes the subject matter of any of Examples 15-24, and wherein generating the routing rules comprises generating routing rules for each of multiple groups of global switches and node switches.

Example 26 includes the subject matter of any of Examples 15-25, and further including sending, by the fabric monitor, the routing rules to each corresponding group of the multiple groups.

Example 27 includes the subject matter of any of Examples 15-26, and wherein monitoring the status of links between the global switches and the node switches comprises receiving data indicative of the status of downlinks in each of the multiple groups.

Example 28 includes the subject matter of any of Examples 15-27, and wherein adjusting the routing rules comprises adjusting the routing rules for multiple groups of global switches and node switches.

Example 29 includes one or more machine-readable storage media comprising a plurality of instructions stored thereon that, in response to being executed, cause a fabric monitor to perform the method of any of Examples 15-28.

Example 30 includes a fabric monitor for efficiently managing link faults between switches, the fabric monitor comprising one or more processors; one or more memory devices having stored therein a plurality of instructions that, when executed, cause the fabric monitor to perform the method of any of Examples 15-28.

Example 31 includes a fabric monitor for efficiently managing link faults between switches, the fabric monitor comprising means for performing the method of any of Examples 15-28.

Example 32 includes a fabric monitor for efficiently managing link faults between switches, the fabric monitor comprising fault manager circuitry to generate routing rules indicative of an ordering of a plurality of global switches connected to a plurality of node switches in a group, monitor a status of links between the global switches and the node switches to determine whether one or more downlinks have failed in the group, adjust, in response to a determination that one or more downlinks have failed in the group, the ordering of the global switches in the routing rules; and network communicator circuitry to send the adjusted routing rules to the group.

Example 33 includes the subject matter of Example 32, and wherein to adjust the ordering of the global switches comprises to assign earlier positions in the ordering to global switches with one or more failed downlinks.

Example 34 includes the subject matter of any of Examples 32 and 33, and wherein to adjust the ordering further comprises to assign a last position in the order to a global switch that has no failed downlinks.

Example 35 includes the subject matter of any of Examples 32-34, and wherein to send the adjusted routing rules comprises to send the adjusted routing rules to at least one global switch or node switch in the group.

Example 36 includes the subject matter of any of Examples 32-35, and wherein the network communicator circuitry is further to send the generated routing rules to the group.

Example 37 includes the subject matter of any of Examples 32-36, and wherein to monitor the status of links between the global switches and the node switches comprises to receive link status data from one or more of the switches in the group.

Example 38 includes the subject matter of any of Examples 32-37, and wherein to monitor the status of links between global switches and node switches in the group comprises to receive data indicative of a status of downlinks from the global switches to the node switches in the group.

Example 39 includes the subject matter of any of Examples 32-38, and wherein to generate the routing rules indicative of an ordering of the global switches comprises to generate routing rules that include an instruction for one or more of the node switches to route packets received from a global switch with a failed downlink to another global switch with a later position in the ordering.

Example 40 includes the subject matter of any of Examples 32-39, and wherein the fault manager circuitry is further to determine whether the group includes at least one global switch with no failed downlinks; and report, in response to a determination that the group does not include a global switch with no failed downlinks, an error message to request maintenance of the group.

Example 41 includes the subject matter of any of Examples 32-40, and wherein to monitor the status of links between global switches and node switches comprises to monitor the status of links between global switches and node switches in multiple groups.

Example 42 includes the subject matter of any of Examples 32-41, and wherein to generate the routing rules comprises to generate routing rules for each of multiple groups of global switches and node switches.

Example 43 includes the subject matter of any of Examples 32-42, and wherein the network communicator circuitry is further to send the routing rules to each corresponding group of the multiple groups.

Example 44 includes the subject matter of any of Examples 32-43, and wherein to monitor the status of links between the global switches and the node switches comprises to receive data indicative of the status of downlinks in each of the multiple groups.

Example 45 includes the subject matter of any of Examples 32-44, and wherein to adjust the routing rules comprises to adjust the routing rules for multiple groups of global switches and node switches.

Example 46 includes a fabric monitor for efficiently managing link faults between switches, the fabric monitor comprising means for generating routing rules indicative of an ordering of a plurality of global switches connected to a plurality of node switches in a group; circuitry for monitoring a status of links between the global switches and the node switches to determine whether one or more downlinks have failed in the group; means for adjusting, in response to a determination that one or more downlinks have failed in the group, the ordering of the global switches in the routing rules; and circuitry for sending the adjusted routing rules to the group.

Example 47 includes the subject matter of Example 46, and wherein the means for adjusting the ordering of the global switches comprises means for assigning earlier positions in the ordering to global switches with one or more failed downlinks.

Example 48 includes the subject matter of any of Examples 46 and 47, and wherein the means for adjusting the ordering further comprises means for assigning a last position in the order to a global switch that has no failed downlinks.

Example 49 includes the subject matter of any of Examples 46-48, and wherein the circuitry for sending the adjusted routing rules comprises circuitry for sending the adjusted routing rules to at least one global switch or node switch in the group.

Example 50 includes the subject matter of any of Examples 46-49, and further including circuitry for sending the generated routing rules to the group.

Example 51 includes the subject matter of any of Examples 46-50, and wherein the circuitry for monitoring the status of links between the global switches and the node switches comprises circuitry for receiving link status data from one or more of the switches in the group.

Example 52 includes the subject matter of any of Examples 46-51, and wherein the circuitry for monitoring the status of links between global switches and node switches in the group comprises circuitry for receiving data indicative of a status of downlinks from the global switches to the node switches in the group.

Example 53 includes the subject matter of any of Examples 46-52, and wherein the means for generating the routing rules indicative of an ordering of the global switches comprises means for generating routing rules that include an instruction for one or more of the node switches to route packets received from a global switch with a failed downlink to another global switch with a later position in the ordering.

Example 54 includes the subject matter of any of Examples 46-53, and further including circuitry for determining whether the group includes at least one global switch with no failed downlinks; and circuitry for reporting, in response to a determination that the group does not include a global switch with no failed downlinks, an error message to request maintenance of the group.

Example 55 includes the subject matter of any of Examples 46-54, and wherein the circuitry for monitoring the status of links between global switches and node switches comprises circuitry for monitoring the status of links between global switches and node switches in multiple groups.

Example 56 includes the subject matter of any of Examples 46-55, and wherein the means for generating the routing rules comprises means for generating routing rules for each of multiple groups of global switches and node switches.

Example 57 includes the subject matter of any of Examples 46-56, and further including circuitry for sending the routing rules to each corresponding group of the multiple groups.

Example 58 includes the subject matter of any of Examples 46-57, and wherein the circuitry for monitoring the status of links between the global switches and the node switches comprises circuitry for receiving data indicative of the status of downlinks in each of the multiple groups.

Example 59 includes the subject matter of any of Examples 46-58, and wherein the means for adjusting the routing rules comprises means for adjusting the routing rules for multiple groups of global switches and node switches.

Example 60 includes a global switch for routing packets, the global switch comprising one or more processors; one or more memory devices having stored therein a plurality of instructions that, when executed, cause the global switch to receive a packet for a destination node coupled to a group of global switches and node switches, wherein the global switch is in the group; determine the node switch connected to the destination node; determine whether a downlink from the global switch to the determined node switch has failed; select, in response to a determination that the downlink has failed, an alternative node switch in the group, wherein the alternative node switch is not connected to the destination node; and send the packet to the alternative node switch to be forwarded to another global switch in the group.

Example 61 includes the subject matter of Example 60, and wherein, when executed, the plurality of instructions further cause the global switch to report data indicative of a status of links between the global switch and the node switches in the group.

Example 62 includes the subject matter of any of Examples 60 and 61, and wherein, when executed, the plurality of instructions further cause the global switch to report a failure of a downlink between the global switch and a node switch to a fabric monitor.

Example 63 includes the subject matter of any of Examples 60-62, and wherein, when executed, the plurality of instructions further cause the global switch to obtain routing rules indicative of an ordering of the global switches in the group.

Example 64 includes the subject matter of any of Examples 60-63, and wherein to obtain the routing rules comprises to receive the routing rules from a fabric monitor.

Example 65 includes the subject matter of any of Examples 60-64, and wherein, when executed, the plurality of instructions further cause the global switch to send the routing rules to one or more of the node switches in the group.

Example 66 includes the subject matter of any of Examples 60-65, and wherein to send the packet to the alternative node switch comprises to additionally send a request to the alternative node switch to forward the packet to another global switch in the group.

Example 67 includes the subject matter of any of Examples 60-66, and wherein to receive the packet comprises to receive the packet from a source external to the group.

Example 68 includes the subject matter of any of Examples 60-67, and wherein to receive the packet comprises to receive the packet from a node switch in the group.

Example 69 includes the subject matter of any of Examples 60-68, and wherein to receive routing rules comprises to receive adjusted routing rules in response to a report of a downlink failure between the global switch and one or more node switches in the group.

Example 70 includes a method for routing packets, the method comprising receiving, by a global switch, a packet for a destination node coupled to a group of global switches and node switches, wherein the global switch is in the group; determining, by the global switch, the node switch connected to the destination node; determining, by the global switch, whether a downlink from the global switch to the determined node switch has failed; selecting, by the global switch and in response to a determination that the downlink has failed, an alternative node switch in the group, wherein the alternative node switch is not connected to the destination node; and sending, by the global switch, the packet to the alternative node switch to be forwarded to another global switch in the group.

Example 71 includes the subject matter of Example 70, and further including reporting, by the global switch, data indicative of a status of links between the global switch and the node switches in the group.

Example 72 includes the subject matter of any of Examples 70 and 71, and further including reporting, by the global switch, a failure of a downlink between the global switch and a node switch to a fabric monitor.

Example 73 includes the subject matter of any of Examples 70-72, and further including obtaining, by the global switch, routing rules indicative of an ordering of the global switches in the group.

Example 74 includes the subject matter of any of Examples 70-73, and wherein obtaining the routing rules comprises receiving the routing rules from a fabric monitor.

Example 75 includes the subject matter of any of Examples 70-74, and further including sending, by the global switch, the routing rules to one or more of the node switches in the group.

Example 76 includes the subject matter of any of Examples 70-75, and wherein sending the packet to the alternative node switch comprises sending a request to the alternative node switch to forward the packet to another global switch in the group.

Example 77 includes the subject matter of any of Examples 70-76, and wherein receiving the packet comprises receiving the packet from a source external to the group.

Example 78 includes the subject matter of any of Examples 70-77, and wherein receiving the packet comprises receiving the packet from a node switch in the group.

Example 79 includes the subject matter of any of Examples 70-78, and wherein receiving routing rules comprises receiving adjusted routing rules in response to a report of a downlink failure between the global switch and one or more node switches in the group.

Example 80 includes one or more machine-readable storage media comprising a plurality of instructions stored thereon that, in response to being executed, cause a global switch to perform the method of any of Examples 70-79.

Example 81 includes a global switch for routing packets, the global switch comprising one or more processors; one or more memory devices having stored therein a plurality of instructions that, when executed, cause the global switch to perform the method of any of Examples 70-79.

Example 82 includes a global switch for routing packets, the global switch comprising means for performing the method of any of Examples 42-51.

Example 83 includes a global switch for routing packets, the global switch comprising network communicator circuitry to receive a packet for a destination node coupled to a group of global switches and node switches, wherein the global switch is in the group; packet router circuitry to determine the node switch connected to the destination node, determine whether a downlink from the global switch to the determined node switch has failed, select, in response to a determination that the downlink has failed, an alternative node switch in the group, wherein the alternative node switch is not connected to the destination node, and send the packet to the alternative node switch to be forwarded to another global switch in the group.

Example 84 includes the subject matter of Example 83, and further including status reporter circuitry to report data indicative of a status of links between the global switch and the node switches in the group.

Example 85 includes the subject matter of any of Examples 83 and 84, and further including status reporter circuitry to report a failure of a downlink between the global switch and a node switch to a fabric monitor.

Example 86 includes the subject matter of any of Examples 83-85, and wherein the packet router circuitry is further to obtain routing rules indicative of an ordering of the global switches in the group.

Example 87 includes the subject matter of any of Examples 83-86, and wherein to obtain the routing rules comprises to receive the routing rules from a fabric monitor.

Example 88 includes the subject matter of any of Examples 83-87, and wherein the network communicator circuitry is further to send the routing rules to one or more of the node switches in the group.

Example 89 includes the subject matter of any of Examples 83-88, and wherein to send the packet to the alternative node switch comprises to additionally send a request to the alternative node switch to forward the packet to another global switch in the group.

Example 90 includes the subject matter of any of Examples 83-89, and wherein to receive the packet comprises to receive the packet from a source external to the group.

Example 91 includes the subject matter of any of Examples 83-90, and wherein to receive the packet comprises to receive the packet from a node switch in the group.

Example 92 includes the subject matter of any of Examples 83-91, and wherein to receive routing rules comprises to receive adjusted routing rules in response to a report of a downlink failure between the global switch and one or more node switches in the group.

Example 93 includes a global switch for routing packets, the global switch comprising circuitry for receiving a packet for a destination node coupled to a group of global switches and node switches, wherein the global switch is in the group; circuitry for determining the node switch connected to the destination node; circuitry for determining whether a downlink from the global switch to the determined node switch has failed; means for selecting, in response to a determination that the downlink has failed, an alternative node switch in the group, wherein the alternative node switch is not connected to the destination node; and circuitry for sending the packet to the alternative node switch to be forwarded to another global switch in the group.

Example 94 includes the subject matter of Example 93, and further including circuitry for reporting data indicative of a status of links between the global switch and the node switches in the group.

Example 95 includes the subject matter of any of Examples 93 and 94, and further including circuitry for reporting a failure of a downlink between the global switch and a node switch to a fabric monitor.

Example 96 includes the subject matter of any of Examples 93-95, and further including circuitry for obtaining routing rules indicative of an ordering of the global switches in the group.

Example 97 includes the subject matter of any of Examples 93-96, and wherein the circuitry for obtaining the routing rules comprises circuitry for receiving the routing rules from a fabric monitor.

Example 98 includes the subject matter of any of Examples 93-97, and further including circuitry for sending the routing rules to one or more of the node switches in the group.

Example 99 includes the subject matter of any of Examples 93-98, and wherein the circuitry for sending the packet to the alternative node switch comprises circuitry for sending a request to the alternative node switch to forward the packet to another global switch in the group.

Example 100 includes the subject matter of any of Examples 93-99, and wherein the circuitry for receiving the packet comprises circuitry for receiving the packet from a source external to the group.

Example 101 includes the subject matter of any of Examples 93-100, and wherein the circuitry for receiving the packet comprises circuitry for receiving the packet from a node switch in the group.

Example 102 includes the subject matter of any of Examples 93-101, and wherein the circuitry for receiving routing rules comprises circuitry for receiving adjusted routing rules in response to a report of a downlink failure between the global switch and one or more node switches in the group.

Example 103 includes a node switch for routing packets, the node switch comprising one or more processors; one or more memory devices having stored therein a plurality of instructions that, when executed, cause the node switch to receive routing rules indicative of an ordering of global switches in a group that includes the global switches and node switches connected to the global switches, wherein the node switch is included in the group; receive a packet from a global switch in the group; determine whether the packet is to be forwarded to another global switch in the group; and determine, in response to a determination that the packet is to be forwarded to another global switch in the group, a later global switch in the ordering indicated in the routing rules, wherein the later global switch is to receive the packet.

Example 104 includes the subject matter of Example 103, and wherein, when executed, the plurality of instructions further cause the node switch to forward the packet to the later global switch in the ordering.

Example 105 includes the subject matter of any of Examples 103 and 104, and wherein, when executed, the plurality of instructions further cause the node switch to dedicate an uplink between the node switch and the later global switch to forward packets to the later global switch.

Example 106 includes the subject matter of any of Examples 103-105, and wherein, when executed, the plurality of instructions further cause the node switch to determine whether the global switch from which the packet was received is the last global switch in the ordering; and report, in response to a determination that the global switch is the last global switch, an error.

Example 107 includes the subject matter of any of Examples 103-106, and wherein to receive the routing rules comprises to receive the routing rules from one or more global switches in the group.

Example 108 includes the subject matter of any of Examples 103-107, and wherein to receive the routing rules comprises to receive the routing rules from a fabric monitor.

Example 109 includes the subject matter of any of Examples 103-108, and wherein to determine whether the packet is to be forwarded to another global switch comprises to compare an identifier of a destination node for the packet to a set of identifiers of nodes connected to the node switch; and determine, in response to a determination that the identifier of the destination node is not in the set, that the packet is to be forwarded.

Example 110 includes the subject matter of any of Examples 103-109, and wherein to determine whether the packet is to be forwarded comprises to receive a request from the global switch to forward the packet to another global switch in the group.

Example 111 includes the subject matter of any of Examples 103-110, and wherein, when executed, the plurality of instructions further cause the node switch to send, in response to a determination that the packet is not to be forwarded to another global switch in the group, the packet to the destination node.

Example 112 includes the subject matter of any of Examples 103-111, and wherein to determine the later global switch comprises to determine a position of the global switch from which the node switch received the packet; and select a global switch at a position in the ordering after the determined position.

Example 113 includes the subject matter of any of Examples 103-112, and wherein, when executed, the plurality of instructions further cause the node switch to forward the packet to the selected global switch with an uplink between the node switch and the later global switch.

Example 114 includes the subject matter of any of Examples 103-113, and wherein, when executed, the plurality of instructions further cause the node switch to dedicate the uplink to forward other packets to the later global switch.

Example 115 includes a method for routing packets, the method comprising receiving, by a node switch, routing rules indicative of an ordering of global switches in a group that includes the global switches and node switches connected to the global switches, wherein the node switch is included in the group; receiving, by the node switch, a packet from a global switch in the group; determining, by the node switch, whether the packet is to be forwarded to another global switch in the group; and determining, by the node switch and in response to a determination that the packet is to be forwarded to another global switch in the group, a later global switch in the ordering indicated in the routing rules, wherein the later global switch is to receive the packet.

Example 116 includes the subject matter of Example 115, and further including forwarding, by the node switch, the packet to the later global switch in the ordering.

Example 117 includes the subject matter of any of Examples 115 and 116, and further including dedicating, by the node switch, an uplink between the node switch and the later global switch to forward packets to the later global switch.

Example 118 includes the subject matter of any of Examples 115-117, and further including determining, by the node switch, whether the global switch from which the packet was received is the last global switch in the ordering; and reporting, by the node switch and in response to a determination that the global switch is the last global switch, an error.

Example 119 includes the subject matter of any of Examples 115-118, and wherein receiving the routing rules comprises receiving the routing rules from one or more global switches in the group.

Example 120 includes the subject matter of any of Examples 115-119, and wherein receiving the routing rules comprises receiving the routing rules from a fabric monitor.

Example 121 includes the subject matter of any of Examples 115-120, and wherein determining whether the packet is to be forwarded to another global switch comprises to comparing an identifier of a destination node for the packet to a set of identifiers or nodes connected to the node switch; and determining, in response to a determination that the identifier of the destination node is not in the set, that the packet is to be forwarded.

Example 122 includes the subject matter of any of Examples 115-121, and wherein determining whether the packet is to be forwarded comprises receiving a request from the global switch to forward the packet to another global switch in the group.

Example 123 includes the subject matter of any of Examples 115-122, and further including sending, by the node switch and in response to a determination that the packet is not to be forwarded to another global switch in the group, the packet to the destination node.

Example 124 includes the subject matter of any of Examples 115-123, and wherein determining the later global switch comprises determining a position of the global switch from which the node switch received the packet; and selecting a global switch at a position in the ordering after the determined position.

Example 125 includes the subject matter of any of Examples 115-124, and further including forwarding the packet to the later global switch with an uplink between the node switch and the later global switch.

Example 126 includes the subject matter of any of Examples 115-125, and further including dedicating, by the node switch, the uplink to forward other packets to the later global switch.

Example 127 includes one or more machine-readable storage media comprising a plurality of instructions stored thereon that, in response to being executed, cause a node switch to perform the method of any of Examples 115-126.

Example 128 includes a node switch for routing packets, the node switch comprising one or more processors; one or more memory devices having stored therein a plurality of instructions that, when executed, cause the node switch to perform the method of any of Examples 115-126.

Example 129 includes a node switch for routing packets, the node switch comprising means for performing the method of any of Examples 115-126.

Example 130 includes a node switch for routing packets, the node switch comprising network communicator circuitry to receive routing rules indicative of an ordering of global switches in a group that includes the global switches and node switches connected to the global switches, wherein the node switch is included in the group, and receive a packet from a global switch in the group; and packet router circuitry to determine whether the packet is to be forwarded to another global switch in the group and determine, in response to a determination that the packet is to be forwarded to another global switch in the group, a later global switch in the ordering indicated in the routing rules, wherein the later global switch is to receive the packet.

Example 131 includes the subject matter of Example 130, and wherein the packet router circuitry is further to forward the packet to the later global switch in the ordering.

Example 132 includes the subject matter of any of Examples 130 and 131, and wherein the packet router circuitry is further to dedicate an uplink between the node switch and the later global switch to forward packets to the later global switch.

Example 133 includes the subject matter of any of Examples 130-132, and wherein the packet router circuitry is further to determine whether the global switch from which the packet was received is the last global switch in the ordering and report, in response to a determination that the global switch is the last global switch, an error.

Example 134 includes the subject matter of any of Examples 130-133, and wherein to receive the routing rules comprises to receive the routing rules from one or more global switches in the group.

Example 135 includes the subject matter of any of Examples 130-134, and wherein to receive the routing rules comprises to receive the routing rules from a fabric monitor.

Example 136 includes the subject matter of any of Examples 130-135, and wherein to determine whether the packet is to be forwarded to another global switch comprises to compare an identifier of a destination node for the packet to a set of identifiers of nodes connected to the node switch; and determine, in response to a determination that the identifier of the destination node is not in the set, that the packet is to be forwarded.

Example 137 includes the subject matter of any of Examples 130-136, and wherein to determine whether the packet is to be forwarded comprises to receive a request from the global switch to forward the packet to another global switch in the group.

Example 138 includes the subject matter of any of Examples 130-137, and wherein the packet router circuitry is further to send, in response to a determination that the packet is not to be forwarded to another global switch in the group, the packet to the destination node.

Example 139 includes the subject matter of any of Examples 130-138, and wherein to determine the later global switch comprises to determine a position of the global switch from which the node switch received the packet; and select a global switch at a position in the ordering after the determined position.

Example 140 includes the subject matter of any of Examples 130-139, and wherein the packet router circuitry is further to forward the packet to the selected global switch with an uplink between the node switch and the later global switch.

Example 141 includes the subject matter of any of Examples 130-140, and wherein the packet router circuitry is further to dedicate the uplink to forward other packets to the later global switch.

Example 142 includes a node switch for routing packets, the node switch comprising circuitry for receiving routing rules indicative of an ordering of global switches in a group that includes the global switches and node switches connected to the global switches, wherein the node switch is included in the group; circuitry for receiving a packet from a global switch in the group; circuitry for determining whether the packet is to be forwarded to another global switch in the group; and means for determining, in response to a determination that the packet is to be forwarded to another global switch in the group, a later global switch in the ordering indicated in the routing rules, wherein the later global switch is to receive the packet.

Example 143 includes the subject matter of Example 142, and further including circuitry for forwarding the packet to the later global switch in the ordering.

Example 144 includes the subject matter of any of Examples 142 and 143, and further including circuitry for dedicating an uplink between the node switch and the later global switch to forward packets to the later global switch.

Example 145 includes the subject matter of any of Examples 142-144, and further including circuitry for determining whether the global switch from which the packet was received is the last global switch in the ordering; and circuitry for reporting, in response to a determination that the global switch is the last global switch, an error.

Example 146 includes the subject matter of any of Examples 142-145, and wherein the circuitry for receiving the routing rules comprises circuitry for receiving the routing rules from one or more global switches in the group.

Example 147 includes the subject matter of any of Examples 142-146, and wherein the circuitry for receiving the routing rules comprises circuitry for receiving the routing rules from a fabric monitor.

Example 148 includes the subject matter of any of Examples 142-147, and wherein the circuitry for determining whether the packet is to be forwarded to another global switch comprises circuitry for comparing an identifier of a destination node for the packet to a set of identifiers or nodes connected to the node switch; and circuitry for determining, in response to a determination that the identifier of the destination node is not in the set, that the packet is to be forwarded.

Example 149 includes the subject matter of any of Examples 142-148, and wherein the circuitry for determining whether the packet is to be forwarded comprises circuitry for receiving a request from the global switch to forward the packet to another global switch in the group.

Example 150 includes the subject matter of any of Examples 142-149, and further including circuitry for sending, in response to a determination that the packet is not to be forwarded to another global switch in the group, the packet to the destination node.

Example 151 includes the subject matter of any of Examples 142-150, and wherein the means for determining the later global switch comprises means for determining a position of the global switch from which the node switch received the packet; and means for selecting a global switch at a position in the ordering after the determined position.

Example 152 includes the subject matter of any of Examples 142-151, and further including circuitry for forwarding the packet to the later global switch with an uplink between the node switch and the later global switch.

Example 153 includes the subject matter of any of Examples 142-152, and further including circuitry for dedicating the uplink to forward other packets to the later global switch.

1. A fabric monitor for efficiently managing link faults between switches, the fabric monitor comprising:
one or more processors;
one or more memory devices having stored therein a plurality of instructions that, when executed, cause the fabric monitor to:
generate routing rules indicative of an ordering of a plurality of global switches connected to a plurality of node switches in a group;
monitor a status of links between the global switches and the node switches to determine whether one or more downlinks have failed in the group;
adjust, in response to a determination that one or more downlinks have failed in the group, the ordering of the global switches in the routing rules; and
send the adjusted routing rules to the group.

2. The fabric monitor of claim 1, wherein to adjust the ordering of the global switches comprises to assign earlier positions in the ordering to global switches with one or more failed downlinks.

3. The fabric monitor of claim 2, wherein to adjust the ordering further comprises to assign a last position in the order to a global switch that has no failed downlinks.

4. The fabric monitor of claim 1, wherein to send the adjusted routing rules comprises to send the adjusted routing rules to at least one global switch or node switch in the group.

5. The fabric monitor of claim 1, wherein, when executed, the plurality of instructions further cause the fabric monitor to send the generated routing rules to the group.

6. The fabric monitor of claim 1, wherein to monitor the status of links between the global switches and the node switches comprises to receive link status data from one or more of the switches in the group.

7. The fabric monitor of claim 1, wherein to monitor the status of links between global switches and node switches in the group comprises to receive data indicative of a status of downlinks from the global switches to the node switches in the group.

8. The fabric monitor of claim 1, wherein to generate the routing rules indicative of an ordering of the global switches comprises to generate routing rules that include an instruction for one or more of the node switches to route packets received from a global switch with a failed downlink to another global switch with a later position in the ordering.

9. The fabric monitor of claim 1, wherein, when executed, the plurality of instructions further cause the fabric monitor to:
determine whether the group includes at least one global switch with no failed downlinks; and
report, in response to a determination that the group does not include a global switch with no failed downlinks, an error message to request maintenance of the group.

10. The fabric monitor of claim 1, wherein to monitor the status of links between global switches and node switches comprises to monitor the status of links between global switches and node switches in multiple groups.

11. The fabric monitor of claim 1, wherein to generate the routing rules comprises to generate routing rules for each of multiple groups of global switches and node switches.

12. The fabric monitor of claim 11, wherein, when executed, the plurality of instructions further cause the fabric monitor to send the routing rules to each corresponding group of the multiple groups.

13. One or more machine-readable storage media comprising a plurality of instructions stored thereon that, in response to being executed, cause a fabric monitor to:
generate routing rules indicative of an ordering of a plurality of global switches connected to a plurality of node switches in a group;
monitor a status of links between the global switches and the node switches to determine whether one or more downlinks have failed in the group;
adjust, in response to a determination that one or more downlinks have failed in the group, the ordering of the global switches in the routing rules; and
send the adjusted routing rules to the group.

14. The one or more machine-readable storage media of claim 13, wherein to adjust the ordering of the global switches comprises to assign earlier positions in the ordering to global switches with one or more failed downlinks.

15. The one or more machine-readable storage media of claim 14, wherein to adjust the ordering further comprises to assign a last position in the order to a global switch that has no failed downlinks.

16. The one or more machine-readable storage media of claim 13, wherein to send the adjusted routing rules comprises to send the adjusted routing rules to at least one global switch or node switch in the group.

17. The one or more machine-readable storage media of claim 13, wherein, when executed, the plurality of instructions further cause the fabric monitor to send the generated routing rules to the group.

18. The one or more machine-readable storage media of claim 13, wherein to monitor the status of links between the global switches and the node switches comprises to receive link status data from one or more of the switches in the group.

19. The one or more machine-readable storage media of claim 13, wherein to monitor the status of links between global switches and node switches in the group comprises to receive data indicative of a status of downlinks from the global switches to the node switches in the group.

20. The one or more machine-readable storage media of claim 13, wherein to generate the routing rules indicative of an ordering of the global switches comprises to generate routing rules that include an instruction for one or more of the node switches to route packets received from a global switch with a failed downlink to another global switch with a later position in the ordering.

21. The one or more machine-readable storage media of claim 13, wherein, when executed, the plurality of instructions further cause the fabric monitor to:
determine whether the group includes at least one global switch with no failed downlinks; and
report, in response to a determination that the group does not include a global switch with no failed downlinks, an error message to request maintenance of the group.

22. The one or more machine-readable storage media of claim 13, wherein to monitor the status of links between global switches and node switches comprises to monitor the status of links between global switches and node switches in multiple groups.

23. The one or more machine-readable storage media of claim 13, wherein to generate the routing rules comprises to generate routing rules for each of multiple groups of global switches and node switches.

24. The one or more machine-readable storage media of claim 23, wherein, when executed, the plurality of instructions further cause the fabric monitor to send the routing rules to each corresponding group of the multiple groups.

25. A fabric monitor for efficiently managing link faults between switches, the fabric monitor comprising:
means for generating routing rules indicative of an ordering of a plurality of global switches connected to a plurality of node switches in a group;
circuitry for monitoring a status of links between the global switches and the node switches to determine whether one or more downlinks have failed in the group;
means for adjusting, in response to a determination that one or more downlinks have failed in the group, the ordering of the global switches in the routing rules; and
circuitry for sending the adjusted routing rules to the group.

26. A method for efficiently managing link faults between switches, the method comprising:
generating, by a fabric monitor, routing rules indicative of an ordering of a plurality of global switches connected to a plurality of node switches in a group;
monitoring, by the fabric monitor, a status of links between the global switches and the node switches to determine whether one or more downlinks have failed in the group;
adjusting, by the fabric monitor and in response to a determination that one or more downlinks have failed in the group, the ordering of the global switches in the routing rules; and
sending, by the fabric monitor, the adjusted routing rules to the group.

27. The method of claim 26, wherein adjusting the ordering of the global switches comprises assigning earlier positions in the ordering to global switches with one or more failed downlinks.

28. The method of claim 27, wherein adjusting the ordering further comprises assigning a last position in the order to a global switch that has no failed downlinks.
